(19) United States
(12) Patent Application Publication
(10) Pub. No.: US 2023/0267384 A1
(43) Pub. Date: Aug. 24, 2023

(54) DISPATCH SYSTEM AND CONTROL METHOD OF THE SAME

(71) Applicant: HONDA MOTOR CO., LTD., Tokyo (JP)

(72) Inventors: Satoshi Suda, Wako-shi (JP); Noriyuki Ishida, Wako-shi (JP)

(21) Appl. No.: 18/160,634

(22) Filed: Jan. 27, 2023

(30) Foreign Application Priority Data
Feb. 22, 2022 (JP) 2022-025915

(51) Int. Cl. G06Q 10/02; G01C 21/34; G06Q 50/30

(52) U.S. Cl. CPC G06Q 10/02; G01C 21/3438; G06Q 50/30; B60L 53/57

(57) ABSTRACT

The dispatch system that dispatches a taxi capable of transporting the usable person P who can use the electric kick scooter includes: a determination unit that determines whether a first taxi that is the taxi loading the electric kick scooter is necessary for the usable person based on a dispatch reservation of the taxi accepted from the usable person; and a first selection unit that selects the taxi to be dispatched for the usable person. The first selection unit selects the first taxi when the determination unit determines that the first taxi is necessary for the usable person, and selects a second taxi that is the taxi not loading the electric kick scooter when the determination unit determines that the first taxi is not necessary for the usable person.

### INCORPORATION BY REFERENCE

The present application claims priority under 35 U.S.C. § 119 to Japanese Patent Application No. 2022-025915 filed on Feb. 22, 2022. The content of the application is incorporated herein by reference in its entirety.

### BACKGROUND OF THE INVENTION

### Field of the Invention

The present invention relates to a dispatch system and a control method of the dispatch system. Description of the Related Art

Conventionally, techniques related to transportation using a vehicle and the like have been known. For example, Japanese Patent Laid-Open No. 2012-252018 discloses a system that presents to a user a traveling state of a case where the user travels to a destination by transportation means other than transportation means the user is actually using. Japanese Patent Laid-Open No. 2012-252018 also discloses a system that presents to a user a traveling state of a case that includes a plurality of types of transportation means such as by car and on foot.

In the transportation including a plurality of types of transportation means as disclosed in Japanese Patent Laid-Open No. 2012-252018, a vehicle and a mobile body other than the vehicle may be used. When dispatching a vehicle for the transportation in such a case, considering whether to dispatch a vehicle carrying a mobile body loaded thereon or to dispatch a vehicle without a mobile body loaded thereon leads to providing convenient dispatch. However, in conventional dispatch, there is no mechanism considering that.

The present invention is made in view of the aforementioned circumstances, and it is an object thereof to provide a dispatch system capable of providing dispatch convenient for a dispatch target person, and to a control method of the dispatch system.

### SUMMARY OF THE INVENTION

One aspect for achieving the foregoing object is a dispatch system dispatching a vehicle to a dispatch target person, the dispatch system including: an acceptance unit configured to accept a dispatch reservation of the vehicle from the dispatch target person; a determination unit configured to determine whether a first vehicle that is the vehicle loading a ridable mobile body is necessary for the dispatch target person, based on the dispatch reservation accepted by the acceptance unit; and a first selection unit configured to select the vehicle to be dispatched for the dispatch target person, in which the first selection unit: selects the first vehicle, when the determination unit determines that the first vehicle is necessary for the dispatch target person; and selects a second vehicle that is the vehicle not loading the mobile body, when the determination unit determines that the first vehicle is not necessary for the dispatch target person.

According to an aspect of the present invention, it is possible to provide dispatch convenient for the dispatch target person.

### BRIEF DESCRIPTION OF THE DRAWINGS

FIG. 1 is a diagram showing an overview of a dispatch system;

FIG. 2 is a diagram showing configurations of a first terminal device and a second terminal device;

FIG. 3 is a diagram showing a configuration of a server device;

FIG. 4 is a flowchart showing operations of the dispatch system;

FIG. 5 is a flowchart showing operations of the dispatch system;

FIG. 6 is a flowchart showing operations of the dispatch system; and

FIG. 7 is a flowchart showing operations of the dispatch system.

### DETAILED DESCRIPTION OF THE PREFERRED EMBODIMENTS

### 1. Overview of Dispatch System

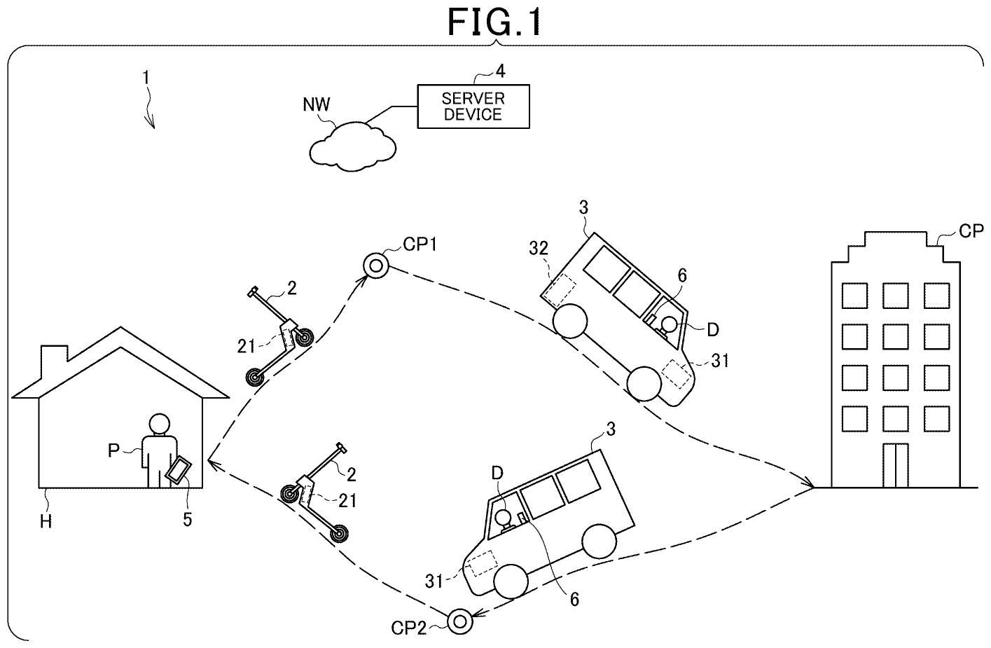

An overview of a dispatch system 1 according to an embodiment will be described with reference to FIG. 1.

FIG. 1 is a diagram showing the overview of the dispatch system 1.

The dispatch system 1 is a system that dispatches a taxi 3 to a dispatch target person. The dispatch target person of the present embodiment is a usable person P who can use an electric kick scooter 2.

The taxi 3 corresponds to a “vehicle” of the present disclosure.

The electric kick scooter 2 is a vehicle that runs by an electric drive motor mounted on the kick scooter. The electric kick scooter 2 may be a standing type or sitting type. The electric kick scooter 2 is an electric vehicle, and includes a battery 21 as a drive source. The electric kick scooter 2 according to the present embodiment is a rental vehicle, which is rented out to the usable person P.

The electric kick scooter 2 corresponds to a “mobile body” of the present disclosure. The battery 21 corresponds to a “first charging device” of the present disclosure.

The electric kick scooter 2 includes a wireless communication device, not shown, and communicates with a server device 4 that is connected to a communication network NW. The communication network NW only needs to be a data communication network, which is a wide area network including a public network, for example. The electric kick scooter 2 transmits first upload information to the server device 4 at prescribed intervals. The first upload information contains a mobile body ID that is identification information of the electric kick scooter 2, information regarding the current location of the electric kick scooter 2, information regarding the charge amount of the battery 21, and the like.

The taxi 3 includes a TCU (Telematics Control Unit) 31 (computer), and communicates with the server device 4 connected to the communication network NW by the TCU 31. The taxi 3 transmits second upload information to the server device 4 at prescribed intervals. The second upload information contains a taxi ID that is identification information of the taxi, information regarding the current location of the taxi 3, and the like.

In the dispatch system 1, the usable person P makes a dispatch reservation of the taxi 3 by a first terminal device 5. The first terminal device 5 is a smartphone, for example, and an application program for dispatching the taxi 3 is installed therein in advance. Hereinafter, this application program is referred to as a “first app”, and a reference numeral “511” is applied thereto. The first terminal device 5 accepts input of various kinds of information related to dispatch such as a riding location and a destination by a function of the first app 511. Then, the first terminal device 5 uses the function of the first app 511 to make a dispatch reservation by transmitting dispatch reservation information indicating the dispatch reservation to the server device 4. The dispatch reservation information transmitted to the server device 4 contains various kinds of information related to dispatch.

In the first dispatch system 1, the server device 4 accepts the dispatch reservation from the usable person P by receiving the dispatch reservation information from the first terminal device 5. The server device 4 dispatches the taxi 3 based on the accepted dispatch reservation. When dispatching the taxi 3, the server device 4 transmits dispatch order information indicating a dispatch order to a second terminal device 6 that is used by a driver D of the taxi 3 to be dispatched. In the dispatch order information, the riding location and the destination of the usable person P that has made the dispatch reservation are recorded. The driver D lets the usable person P ride at the riding location recorded in the dispatch order information, and transports the usable person P to the destination recorded in the dispatch order information.

In the present embodiment, the taxi 3 dispatched by the server device 4 is a first taxi 3A or a second taxi 3B. The first taxi 3A is a taxi 3 with the electric kick scooter 2 loaded thereon. The second taxi 3B is a taxi 3 without the electric kick scooter 2 loaded thereon.

The first taxi 3A corresponds to a “first vehicle” of the present disclosure. The second taxi 3B corresponds to a “second vehicle” of the present disclosure.

In the example of FIG. 1, illustrated is a state where the usable person P has the taxi 3 dispatched and moves from a home H to a company CP. In the example of FIG. 1, the usable person P makes a dispatch reservation at the home H or the like, moves to a point CP1 as a riding location by the electric kick scooter 2, and moves from the point CP1 to the company CP by the taxi 3. The server device 4 dispatches the second taxi 3B to the usable person P for moving from the point CP1. This allows the usable person P to use the second taxi 3B and leave the electric kick scooter 2, thereby making it possible to go to the company CP without bringing the electric kick scooter 2. Note that the example of FIG. 1 illustrates a case where the second taxi 3B with a battery 32 loaded thereon is dispatched for moving from the point CP1 to the company CP. The battery 32 is a battery capable of charging the battery 21 of the electric kick scooter 2.

The battery 32 corresponds to a “second charging device” of the present disclosure.

Furthermore, the example of FIG. 1 illustrates a state where the usable person P has the taxi 3 dispatched and moves from the company CP to the home H. In the example of FIG. 1, the usable person P makes a dispatch reservation at the company CP or the like, moves from the company CP to a point CP2 by the taxi 3, and moves from the point CP2 to the home H by the electric kick scooter 2. The server device 4 dispatches the first taxi 3A to the usable person P for moving from the company CP. This makes it possible for the usable person P to move from the point CP2 to the home H using the electric kick scooter 2, even if the usable person P has no electric kick scooter 2 carried when moving from the company CP.

The dispatch system 1 includes the first terminal device 5 and the second terminal device 6.

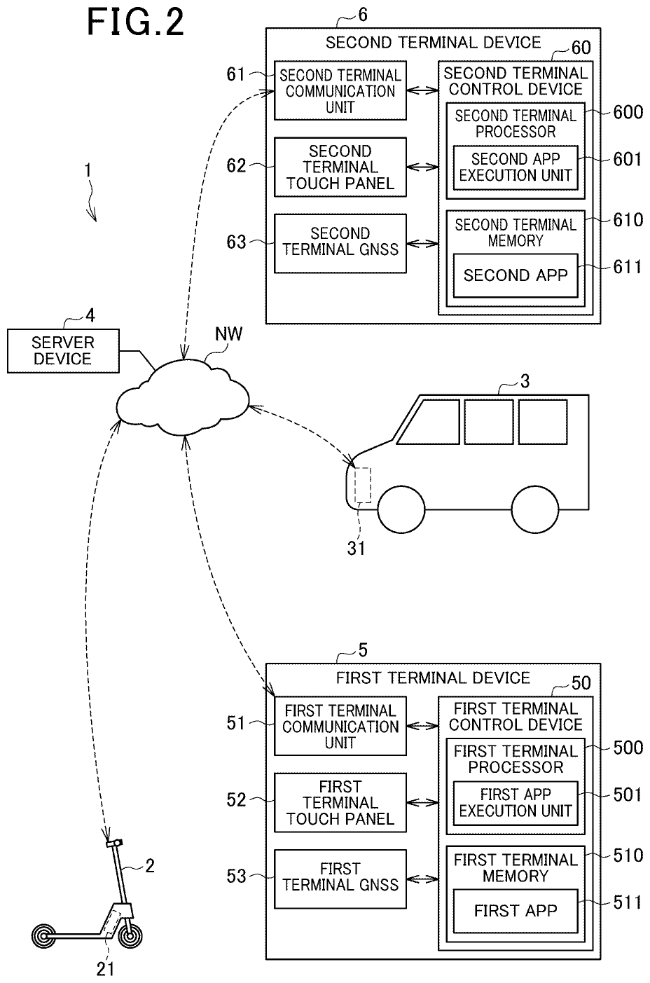

FIG. 2 is a block diagram showing the configurations of the first terminal device 5 and the second terminal device 6.

### 2. Configuration of First Terminal Device

First, the configuration of the first terminal device 5 will be described.

The first terminal device 5 includes a first terminal control device 50, a first terminal communication unit 51, a first terminal touch panel 52, and a first terminal GNSS (Global Navigation Satellite System) 53.

The first terminal control device 50 includes a first terminal processor 500 and a first terminal memory 510, and controls each unit of the first terminal device 5. The first terminal processor 500 is a processor such as a CPU (Central Processing Unit). The first terminal processor 500 functions as a first app execution unit 501 by reading out and executing the first app 511 stored in the first terminal memory 510. The first terminal memory 510 is a memory for storing programs and data. The first terminal memory 510 stores the first app 511 and programs other than the first app 511 as well as data to be processed by the first terminal processor 500. The first terminal memory 510 includes a nonvolatile storage area. Note that the first terminal memory 510 may include a volatile storage area, and configure a work area of the first terminal processor 500.

To the first terminal control device 50, the first terminal communication unit 51, the first terminal GNSS 53, and the first terminal touch panel 52 are connected. Note that other devices may further be connected to the first terminal control device 50.

The first terminal communication unit 51 may include communication hardware such as an antenna and a wireless communication circuit, and communicates with the server device 4 via the communication network NW.

The first terminal touch panel 52 is a touch panel. The first terminal touch panel 52 displays various kinds of information under control of the first terminal control device 50. Furthermore, the first terminal touch panel 52 outputs signals corresponding to touch operations to the first terminal control device 50.

The first terminal GNSS 53 measures the current location of the first terminal device 5. The first terminal GNSS 53 outputs information of the measured current location to the first terminal control device 50.

As described above, the first terminal processor 500 functions as the first app execution unit 501.

The first app execution unit 501 communicates with the server device 4 via the first terminal communication unit 51. The first app execution unit 501 displays various kinds of information related to dispatch on the first terminal touch panel 52. The first app execution unit 501 accepts various kinds of input from the usable person P via the first terminal touch panel 52.

### 3. Configuration of Second Terminal Device

Next, the configuration of the second terminal device 6 will be described.

The second terminal device 6 includes a second terminal control device 60, a second terminal communication unit 61, a second terminal touch panel 62, and a second terminal GNSS 63.

The second terminal control device 60 includes a second terminal processor 600 and a second terminal memory 610, and controls each unit of the second terminal device 6. The second terminal processor 600 is a processor such as a CPU. The second terminal processor 600 functions as a second app execution unit 601 by reading out and executing a second app 611 stored in the second terminal memory 610. The second terminal memory 610 is a memory for storing programs and data. The second terminal memory 610 stores the second app 611 and programs other than the second app 611 as well as data to be processed by the second terminal processor 600. The second terminal memory 610 includes a nonvolatile storage area. Note that the second terminal memory 610 may include a volatile storage area, and configure a work area of the second terminal processor 600.

To the second terminal control device 60, the second terminal communication unit 61, the second terminal GNSS 63, and the second terminal touch panel 62 are connected. Note that other devices may further be connected to the second terminal control device 60.

The second terminal communication unit 61 may include communication hardware such as an antenna and a wireless communication circuit, and communicates with the server device 4 via the communication network NW.

The second terminal touch panel 62 is a touch panel. The second terminal touch panel 62 displays various kinds of information under control of the second terminal control device 60. Furthermore, the second terminal touch panel 62 outputs signals corresponding to touch operations to the second terminal control device 60.

The second terminal GNSS 63 measures the current location of the second terminal device 6. The second terminal GNSS 63 outputs information of the measured current location to the second terminal control device 60.

As described above, the second terminal processor 600 functions as the second app execution unit 601.

The second app execution unit 601 communicates with the server device 4 via the second terminal communication unit 61. The second app execution unit 601 displays various kinds of information related to dispatch on the second terminal touch panel 62. The second app execution unit 601 accepts various kinds of input from the driver D via the second terminal touch panel 62.

### 4. Configuration of Server Device

The dispatch system 1 includes the server device 4.

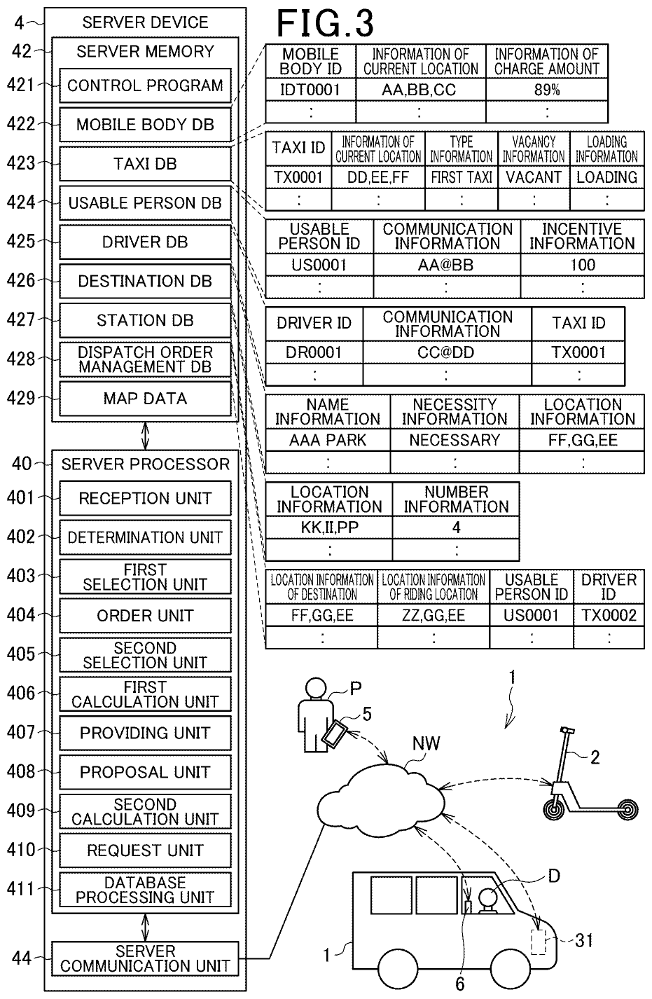

FIG. 3 is a diagram showing the configuration of the server device 4.

The server device 4 includes a server processor 40 that is a processor such as a CPU, a server memory 42 that is a memory for storing programs and data, and a server communication unit 44.

The server processor 40 functions as a reception unit 401, a determination unit 402, a first selection unit 403, an order unit 404, a second selection unit 405, a first calculation unit 406, a providing unit 407, a proposal unit 408, a second calculation unit 409, a request unit 410, and a database processing unit 411 by reading out and executing a control program 421 stored in the server memory 42.

The reception unit 401 corresponds to an “acceptance unit” of the present disclosure.

The server memory 42 stores programs to be executed by the server processor 40 and data to be processed by the server processor 40. The server memory 42 stores the control program 421 that is executed by the server processor 40, a mobile body DB (database) 422, a taxi DB 423, a usable person DB 424, a driver DB 425, a destination DB 426, a station DB 427, a dispatch order management DB 428, map data 429, and other various kinds of data. The server memory 42 has a nonvolatile storage area. Furthermore, the server memory 42 may include a volatile storage area, and configure a work area of the server processor 40.

In the mobile body DB 422, for each of the electric kick scooters 2, a record carrying information of the electric kick scooter 2 is stored. The information of the electric kick scooter 2 in a single record contains a mobile body ID, information regarding the current location of the electric kick scooter 2, and information regarding the charge amount of the battery 21. Note that the information regarding the current location of the electric kick scooter 2 and the information regarding the charge amount of the battery 21 are appropriately updated based on the first upload information.

In the taxi DB 423, for each of the taxies 3, a record carrying information of the taxi 3 is stored. The information of the taxi 3 in a single record contains a taxi ID, information regarding the current location of the taxi 3, type information indicating whether the taxi is the first taxi 3A or the second taxi 3B, vacancy information indicating whether the taxi is vacant, and loading information indicating whether the battery 32 is loaded. Note that the information regarding the current location of the taxi 3 is appropriately updated based on the second upload information. Furthermore, the vacancy information is updated appropriately in accordance with a dispatch order made for the taxi 3 and completion of the transportation by the taxi 3. Moreover, the loading information is updated appropriately according to whether the electric kick scooter 2 is rented out and whether the electric kick scooter 2 is loaded.

In the usable person DB 424, for each of the usable persons P, a record carrying information of the usable person P is stored. The information of the usable person P in a single record contains a usable person ID, communication information for communicating with the first terminal device 5 of the usable person P, and incentive information that is the information of the incentive.

In the driver DB 425, for each of the drivers D, a record carrying information of the driver D is stored. The information of the driver D in a single record contains a driver ID, communication information for communicating with the second terminal device 6, and a taxi ID. When the taxi 3 that the driver D is driving changes, the taxi ID associated with the driver ID is appropriately changed in the driver DB 425.

In the destination DB 426, for each of the destinations, a record carrying information of the destination is stored. The information of the destination in a single record contains name information of the destination, necessity information indicating whether the electric kick scooter 2 is necessary for reaching the destination, and location information of the destination. The necessity information is appropriately set in advance for each of the destinations.

In the station DB 427, for each of the stations where the electric kick scooter 2 can be parked, a record carrying information of the station is stored. The information of the station in a single record contains location information of the station and number information indicating the number of the electric kick scooters 2 parked in the station. The number indicated in the number information is appropriately changed, when the number of the electric kick scooters 2 parked in the station changes.

In the dispatch order management DB 428, for each of the dispatch orders, a record carrying information of the dispatch order is stored. The information of the dispatch order in a single record contains location information of the destination of the usable person P, location information of the riding location of the usable person P, the usable person ID, and the driver ID.

The map data 429 is data containing road map information, facility information of various facilities and the like, data for map matching, and the like. The road map information is configured with a road network where roads on a map are represented by lines, and contains information about links in which intersections, branch points, and the like are defined to be nodes to divide a road into a plurality of sections, and connections between the nodes are defined as links. The facility information indicates the locations of the facilities, the names of the facilities, and the like.

The server communication unit 44 includes communication hardware such as a communication circuit. The server communication unit 44 communicates with the electric kick scooter 2, the taxi 3, the first terminal device 5, and the second terminal device 6 via the communication network NW.

As described above, the server processor 40 functions as the reception unit 401, the determination unit 402, the first selection unit 403, the order unit 404, the second selection unit 405, the first calculation unit 406, the providing unit 407, the proposal unit 408, the second calculation unit 409, the request unit 410, and the database processing unit 411.

The reception unit 401 receives information from the electric kick scooter 2, the taxi 3, the first terminal device 5, and the second terminal device 6 via the server communication unit 44.

The determination unit 402 determines whether the first taxi 3A is necessary for the usable person P. The determination unit 402 outputs a determination result to the first selection unit 403.

The first selection unit 403 selects the taxi 3 to be dispatched for the usable person P. The first selection unit 403 specifies a single record from the taxi DB 423 to make selection of the taxi 3. The first selection unit 403 selects the type of taxi 3 corresponding to the determination result of the determination unit 402. When the determination result of the determination unit 402 indicates that the first taxi 3A is necessary, the first selection unit 403 selects the first taxi 3A as the taxi 3 to be dispatched for the usable person P. When the determination result of the determination unit 402 indicates that the first taxi 3A is not necessary, the first selection unit 403 selects the second taxi 3B as the taxi 3 to be dispatched for the usable person P.

The order unit 404 sends a dispatch order to the taxi 3 selected by the first selection unit 403. The order unit 404 communicates with the second terminal device 6 via the server communication unit 44. The order unit 404 makes a dispatch order by transmitting dispatch order information to the second terminal device 6 used by the driver D of the taxi 3 that is selected by the first selection unit 403. Specifically, the order unit 404 specifies, from the driver DB 425, the record having the taxi ID of the record specified by the first selection unit 403, and transmits the dispatch order information to the second terminal device 6 according to the communication information contained in the specified record.

The second selection unit 405 selects transportation means used from the riding location to the destination. The second selection unit 405 selects the transportation means from first transportation means, second transportation means, and third transportation means. The first transportation means is means of transportation using only the taxi 3. The second transportation means is means of transportation using only the electric kick scooter 2. The third transportation means is means of transportation using the taxi 3 and the electric kick scooter 2. The second selection unit 405 outputs information of the selected transportation means to the first calculation unit 406 and the providing unit 407.

The first calculation unit 406 calculates required time necessary for the transportation from the riding location to the destination. The first calculation unit 406 calculates the required time corresponding to the transportation means selected by the second selection unit 405. The first calculation unit 406 outputs information of the calculated required time to the providing unit 407.

The providing unit 407 provides the transportation means selected by the second selection unit 405 and the required time calculated by the first calculation unit 406 to the usable person P. Specifically, the providing unit 407 communicates with the first terminal device 5 via the server communication unit 44, and transmits information of the transportation means selected by the second selection unit 405 and information of the required time calculated by the first calculation unit 406 to the first terminal device 5.

The proposal unit 408 proposes the use of the electric kick scooter 2 to the usable person P in accordance with the traffic condition from the riding location of the usable person P to the destination of the usable person P. The proposal unit 408 searches for a route from the riding location of the usable person P to the destination of the usable person P, acquires the traffic condition of the searched route from a prescribed server connected to the communication network NW, and proposes the use of the electric kick scooter 2 in accordance with the acquired traffic condition. For example, the proposal unit 408 proposes the use of the electric kick scooter 2 when the traffic condition until reaching the destination includes a traffic jam, and does not propose the use of the electric kick scooter 2 when the traffic condition until reaching the destination includes no traffic jam. When proposing the use of the electric kick scooter 2, the proposal unit 408 communicates with the first terminal device 5 via the server communication unit 44, and transmits recommendation information for recommending the use of the electric kick scooter 2 to the first terminal device 5.

When the usable person P uses the electric kick scooter 2 proposed by the proposal unit 408, the second calculation unit 409 calculates an incentive to be awarded to the usable person P. The second calculation unit 409 may calculate an incentive such that the value thereof varies depending on the use timing and the like, or may calculate a fixed incentive regardless of the use timing and the like. Upon calculating the incentive, the second calculation unit 409 outputs information of the calculated incentive to the database processing unit 411. When outputting information of the calculated incentive to the database processing unit 411, the second calculation unit 409 associates the usable person ID of the usable person P as the grantee with the information of the calculated incentive. Note that the incentive calculated by the second calculation unit 409 is, for example, money or a discount amount that can be used when making a prescribed payment.

When the electric kick scooter 2 loaded on the first taxi 3A is rented out, the request unit 410 requests the driver D of the first taxi 3A to load the electric kick scooter 2.

The database processing unit 411 updates various kinds of databases stored in the server memory 42.

### 5. Operations of Dispatch System

Next, operations of each unit of the dispatch system 1 will be described.

First, the operations of the dispatch system 1 related to a dispatch reservation will be described.

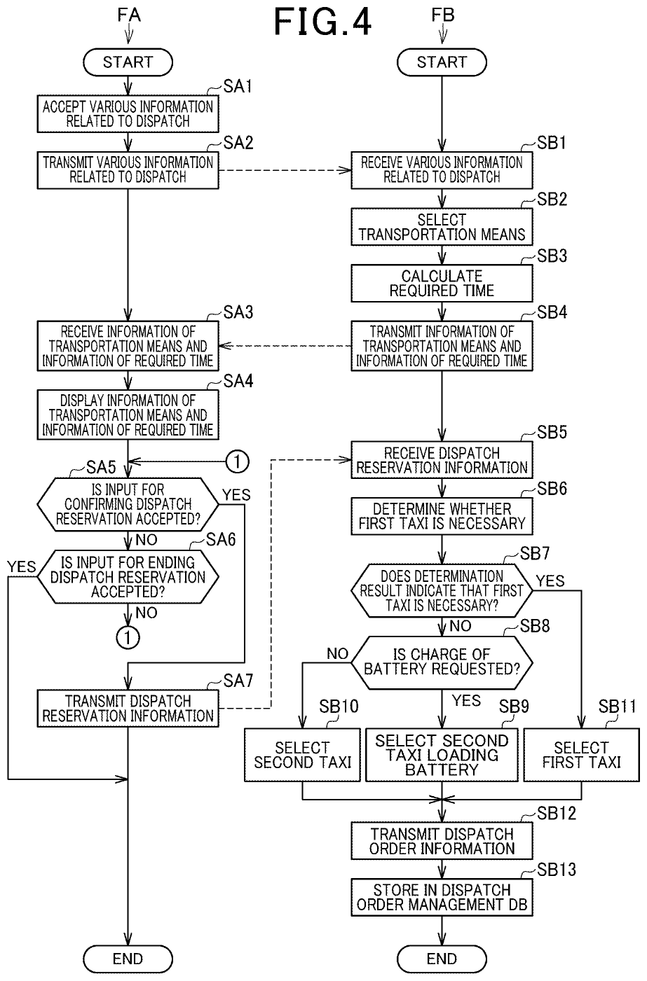

FIG. 4 shows flowcharts indicating the operations of the dispatch system 1.

In FIG. 4, a flowchart FA indicates the operation of the first terminal device 5, and a flowchart FB indicates the operation of the server device 4.

The first app execution unit 501 of the first terminal device 5 accepts input of various kinds of information related to dispatch (Step SA1).

In the present embodiment, items of input information accepted in Step SA1 are the following items.

Item 1: Riding location

Item 2: Name of destination

Item 3: Location of destination

Item 4: Whether to use the electric kick scooter 2 before riding in the taxi

Item 5: Whether to use electric kick scooter 2 loaded on the taxi 3, when using the electric kick scooter 2 before riding in the taxi

Item 6: Whether to charge the electric kick scooter 2 while riding in the taxi

The first app execution unit 501 transmits various kinds of input information related to dispatch to the server device 4 (Step SA2).

The reception unit 401 of the server device 4 receives the various kinds of information related to dispatch from the first terminal device 5 (Step SB1).

Then, the second selection unit 405 selects the transportation means based on the various kinds of received information related to dispatch (Step SB2).

Here, selection by the second selection unit 405 will be described in detail.

The second selection unit 405 specifies, from the destination DB 426, the record carrying the information of the name and location of the destination written in the various kinds of information related to dispatch.

Then, the second selection unit 405 determines whether the necessity information in the specified record indicates that the electric kick scooter 2 is necessary.

When the necessity information in the specified record indicates that the electric kick scooter 2 is not necessary, the second selection unit 405 selects the first transportation means as the transportation means from the riding location to the destination.

In the meantime, when the necessity information in the specified record indicates that the electric kick scooter 2 is necessary, the second selection unit 405 selects the second transportation means or the third transportation means in accordance with the traffic condition from the riding location to the destination written in the various kinds of information related to dispatch. Note that the second selection unit 405 communicates with a prescribed server via the server communication unit 44, and acquires the traffic condition from the prescribed server. For example, when the acquired traffic condition indicates a traffic jam, the second selection unit 405 selects the second transportation means as the transportation means from the riding location to the destination. In the meantime, when the acquired traffic condition indicates no traffic jam, the second selection unit 405 selects the third transportation means as the transportation means from the riding location to the destination.

When the second selection unit 405 selects the transportation means, the first calculation unit 406 calculates the required time corresponding to the transportation means selected by the second selection unit 405 (Step SB3).

Step SB3 will be described.

When the second selection unit 405 selects the first transportation means, the first calculation unit 406 calculates the required time for a case where the taxi 3 is used for moving from the riding location to the destination written in the various kinds of information related to dispatch.

When the second selection unit 405 selects the second transportation means, the first calculation unit 406 calculates the required time for a case where the electric kick scooter 2 is used for moving from the riding location to the destination written in the various kinds of information related to dispatch.

When the second selection unit 405 selects the third transportation means, the first calculation unit 406 calculates the required time for a case where the taxi 3 and the electric kick scooter 2 are used for moving from the riding location to the destination written in the various kinds of information related to dispatch.

Then, the providing unit 407 transmits the information of the transportation means selected by the second selection unit 405 and the information of the required time calculated by the first calculation unit 406 to the first terminal device 5 (Step SB4).

As shown in the flowchart FA, the first app execution unit 501 of the first terminal device 5 receives the information of the transportation means and the information of the required time from the server device 4 (Step SA3).

Then, the first app execution unit 501 displays the information of the transportation means and the information of the required time received in Step SA3 on the first terminal touch panel 52 (Step SA4).

As described above, since the transportation means and the required time are provided, the usable person P making a dispatch reservation can grasp, in the dispatch reservation, what kind of transportation means to be taken to reach the destination and how long it takes from the riding location to the destination. Thereby, the dispatch system 1 can increase the convenience for the usable person P in the dispatch reservation, so that it is possible to provide dispatch convenient for the usable person P. Furthermore, the dispatch system 1 selects the transportation means based on the traffic condition and the destination of the usable person P. Depending on the destination, there may be a case where the taxi 3 only goes to the surroundings of the destination. Furthermore, depending on the destination, there may be a case where it is faster to move by the electric kick scooter 2 than by the taxi 3 in accordance with the traffic condition. As described, since the transportation means is selected based on the traffic condition and the destination of the usable person P, it is possible to provide the useful transportation means for the usable person P.

Then, the first app execution unit 501 determines whether input for confirming the dispatch reservation has been accepted (Step SA5).

When determined that input for confirming the dispatch reservation has not been accepted (NO in Step SA5), the first app execution unit 501 determines whether input for ending the dispatch reservation has been accepted (Step SA6).

When determined that input for ending the dispatch reservation has not been accepted (NO in Step SA6), the first app execution unit 501 performs determination of Step SA5 again.

In the meantime, when determined that input for ending the dispatch reservation has been accepted (YES in Step SA6), the first app execution unit 501 ends the processing.

Returning to describing Step SA5, when determined that input for confirming the dispatch reservation has been accepted (YES in Step SA5), the first app execution unit 501 transmits the dispatch reservation information to the server device 4 (Step SA7). The dispatch reservation information contains the usable person ID. Furthermore, the dispatch reservation information contains various kinds of information accepted in Step SA1. That is, in the dispatch reservation indicated in the dispatch reservation information, input contents of the items 1, 2, 3, 4, 5, and 6 accepted in Step SA1 are set. Note that the usable person ID is stored in advance in the first terminal memory 510.

As shown in the flowchart FB, the reception unit 401 of the server device 4 receives the dispatch reservation information (Step SB5).

Then, the determination unit 402 determines whether the first taxi 3A is necessary for the usable person P based on the dispatch reservation information received in Step SB5 (Step SB6).

Step SB6 will be described in detail.

The determination unit 402 specifies, from the destination DB 426, the record carrying the information of the location and name of the destination recorded in the dispatch reservation information. Then, the determination unit 402 determines whether the necessity information in the specified record indicates that the electric kick scooter 2 is necessary.

When the necessity information in the specified record does not indicate that the electric kick scooter 2 is necessary, the determination unit 402 determines that the first taxi 3A is not necessary.

When the necessity information in the specified record indicates that the electric kick scooter 2 is necessary, the determination unit 402 determines whether it is recorded in the dispatch reservation information that the electric kick scooter 2 is to be used before riding in the taxi. When determined that it is recorded in the dispatch reservation information that the electric kick scooter 2 is to be used before riding in the taxi, the determination unit 402 determines whether it is recorded in the dispatch reservation information that the electric kick scooter 2 loaded on the taxi 3 is to be used. The determination unit 402 determines that the first taxi 3A is necessary when determined that it is recorded to use the electric kick scooter 2 loaded on the taxi 3, and determines that the first taxi 3A is not necessary when determined that it is not recorded to use the electric kick scooter 2 loaded on the taxi 3.

In the meantime, when determined that it is recorded in the dispatch reservation information that the electric kick scooter 2 is not used before riding in the taxi, the determination unit 402 determines that the first taxi 3A is necessary.

The first selection unit 403 determines whether the determination result of the determination unit 402 indicates that the first taxi 3A is necessary (Step SB7).

When the determination result of the determination unit 402 does not indicate that the first taxi 3A is necessary, that is, when it indicates that the first taxi 3A is not necessary (NO in Step SB7), the first selection unit 403 determines whether the usable person P is requesting to charge the battery 21 (Step SB8). When it is recorded in the dispatch reservation information received in Step SB5 to charge the electric kick scooter 2 while riding in the taxi, the first selection unit 403 determines positive in Step SB8. In the meantime, when it is recorded in the dispatch reservation information received in Step SB5 not to charge the electric kick scooter 2 while riding in the taxi, the first selection unit 403 determines negative in Step SB8.

When determined that it is requested to charge the battery 21 (YES in Step SB8), the first selection unit 403 refers to type information, vacancy information, and loading information in each of the records stored in the taxi DB 423 and selects the second taxi 3B that is vacant and carries the battery 32 loaded thereon (Step SB9). When a plurality of the second taxies 3B loading the battery 32 are selectable in Step SB9, the first selection unit 403 refers to the information of the current location in the records stored in the taxi DB 423 and selects the second taxi 3B closest to the riding location recorded in the dispatch reservation information received in Step SB5.

When determined that it is not requested to charge the battery 21 (NO in Step SB8), the first selection unit 403 refers to type information and vacancy information in each of the records stored in the taxi DB 423 and selects the second taxi 3B that is vacant (Step SB10). The second taxi 3B selected in Step SB10 may or may not carry the battery 32 loaded thereon. When a plurality of the second taxies 3B are selectable in Step SB10, the first selection unit 403 selects the second taxi 3B closest to the riding location recorded in the dispatch reservation information received in Step SB5.

Returning to describing Step SB7, when the determination result of the determination unit 402 indicates that the first taxi 3A is necessary (YES in Step SB7), the first selection unit 403 refers to the type information and vacancy information in each of the records stored in the taxi DB 423, and selects the first taxi 3A that is vacant (Step SB11). When a plurality of the first taxies 3A are selectable in Step SB11, the first selection unit 403 selects the first taxi 3A closest to the riding location recorded in the dispatch reservation information, as in Step SB9.

The order unit 404 transmits the dispatch order information to the second terminal device 6 used by the driver D of the taxi 3 selected in one of Step SB9, Step SB10, and Step SB11 (Step SB12).

Then, the database processing unit 411 generates a record having the location information of the destination recorded in the dispatch reservation information received in Step SB5, the location information of the riding location stored in the dispatch reservation information, the usable person ID recorded in the dispatch reservation information, and the driver ID of the driver D of the taxi 3 selected by the first selection unit 403, and stores the generated record anew in the dispatch order management DB 428 (Step SB13).

Next, described are the operations of the dispatch system 1 when transportation by the taxi 3 is completed.

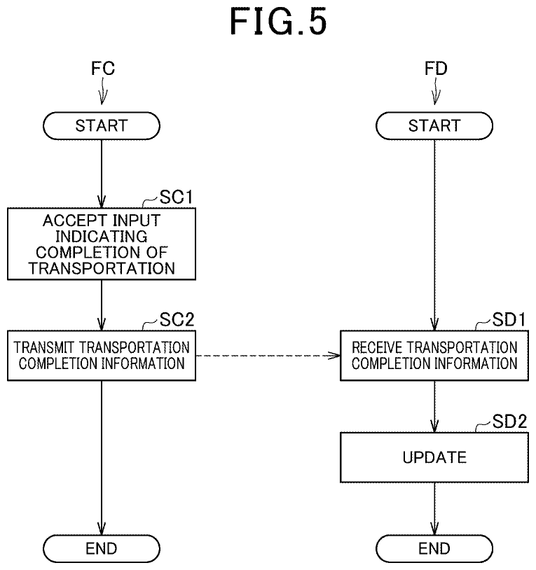

FIG. 5 shows flowcharts indicating the operations of the dispatch system 1.

In FIG. 5, a flowchart FC indicates the operation of the second terminal device 6, and a flowchart FD indicates the operation of the server device 4.

The second app execution unit 601 of the second terminal device 6 accepts input indicating completion of the transportation (Step SC1).

Then, the second app execution unit 601 transmits, to the server device 4, transportation completion information indicating that the transportation is completed (Step SC2). The transportation completion information contains the driver ID. Note that the driver ID is stored in advance in the second terminal memory 610 of the second terminal device 6.

The reception unit 401 of the server device 4 receives the transportation completion information from the second terminal device 6 (Step SD1).

Then, the database processing unit 411 updates the taxi DB 423 and the dispatch order management DB 428 based on the driver ID contained in the transportation completion information (Step SD2).

Step SD2 will be described.

The database processing unit 411 specifies the record carrying the driver ID contained in the transportation completion information from the taxi DB 423, and changes the vacancy information in the specified record to vacant.

The database processing unit 411 specifies the record carrying the driver ID contained in the transportation completion information from the dispatch order management DB 428, and erases the specified record from the dispatch order management DB 428.

As described above, the electric kick scooter 2 loaded on the first taxi 3A can be rented out to the usable person P. Therefore, there may be a case where the electric kick scooter 2 loaded on the first taxi 3A is rented out to the usable person P who has made a dispatch reservation.

Next, the operations of the dispatch system 1 when the electric kick scooter 2 loaded on the first taxi 3A is rented out will be described.

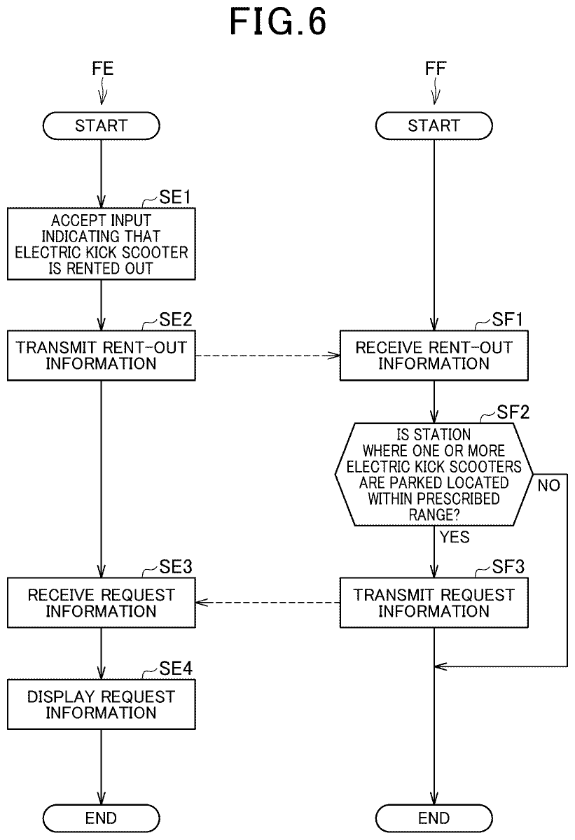

FIG. 6 shows flowcharts indicating the operations of the dispatch system 1.

In FIG. 6, a flowchart FE indicates the operation of the second terminal device 6, and a flowchart FF indicates the operation of the server device 4.

As shown in the flowchart FE, the second app execution unit 601 of the second terminal device 6 accepts input indicating that the electric kick scooter 2 is rented out (Step SE1).

Then, the second app execution unit 601 transmits, to the server device 4, rent-out information indicating that the electric kick scooter 2 is being rented out (Step SE2). The rent-out information contains the driver ID.

As shown in the flowchart FF, the reception unit 401 of the server device 4 receives the rent-out information (Step SF1).

Then, the request unit 410 refers to the taxi DB 423, the driver DB 425, the station DB 427, and the map data 429 to determine whether the station where one or more electric kick scooters 2 are parked is located within a prescribed range (for example, within a radius of 1 km) from the current location of the first taxi 3A (Step SF2).

When the request unit 410 determines that the station where one or more electric kick scooters 2 are parked is not located within the prescribed range from the current location of the first taxi 3A (NO in Step SF2), the server processor 40 ends the processing.

In the meantime, when determined that the station where one or more electric kick scooters 2 are parked is located within the prescribed range from the current location of the first taxi 3A (YES in Step SF2), the request unit 410 transmits request information for requesting to load the electric kick scooter 2 to the second terminal device 6 (Step SF3). The request information contains the location information of the station where one or more electric kick scooters 2 are parked.

As shown in the flowchart FE, the second app execution unit 601 of the second terminal device 6 receives the request information from the server device 4 (Step SE3).

Then, the second app execution unit 601 displays the received request information on the second terminal touch panel (Step SE4).

As described above, the proposal unit 408 proposes the use of the electric kick scooter 2. The proposal unit 408 monitors the traffic condition to the destination from after the dispatch reservation is made until transportation by the dispatched first taxi 3A is completed, and proposes the use of the electric kick scooter 2 in accordance with the traffic condition.

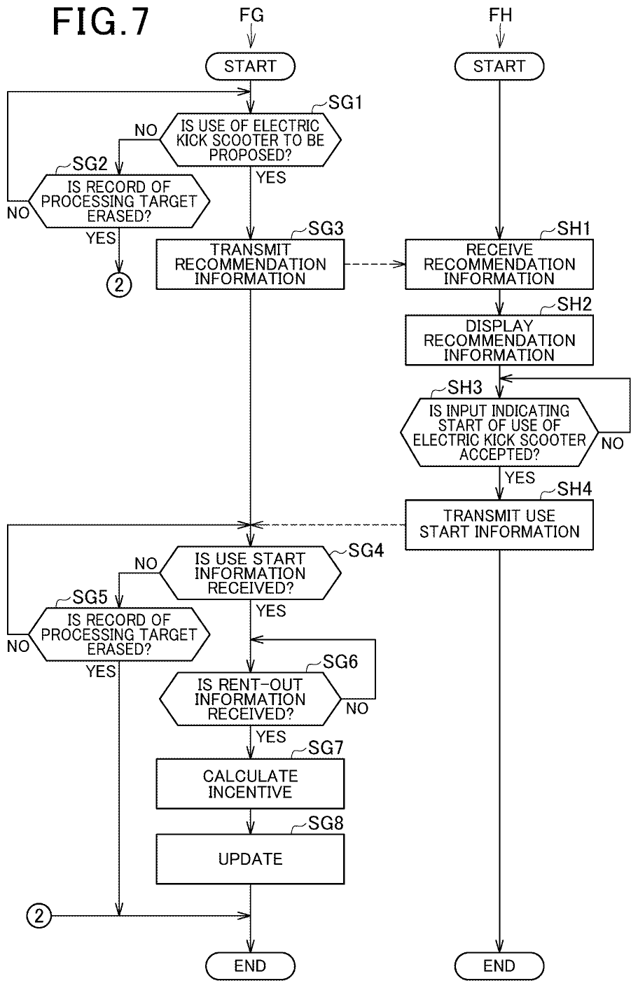

By referring to FIG. 7, the operations of the dispatch system 1 related to proposal of the use of the electric kick scooter 2 will be described.

In FIG. 7, a flowchart FG indicates the operation of the server device 4, and a flowchart FH indicates the operation of the first terminal device 5. As for the flowchart FG, a single record stored in the dispatch order management DB 428 is taken as a target of processing.

The proposal unit 408 of the server device 4 determines whether to propose the use of the electric kick scooter 2 (Step SG1). When the traffic condition from the riding location to the destination indicates a traffic jam, the proposal unit 408 determines positive in Step SG1. When the traffic condition from the riding location to the destination indicates no traffic jam, the proposal unit 408 determines negative in Step SG1.

When determined not to propose the use of the electric kick scooter 2 (Step SG1), the proposal unit 408 determines whether the record as the processing target is erased from the dispatch order management DB 428 (Step SG2).

When the proposal unit 408 determines that the record as the processing target is erased from the dispatch order management DB 428 (YES in Step SG2), the server processor 40 ends the processing.

In the meantime, when determined that the record as the processing target is not erased from the dispatch order management DB 428 (NO in Step SG2), the proposal unit 408 performs the processing of Step SG1 again.

Returning to describing Step SG1, when determined to propose the use of the electric kick scooter 2 (YES in Step SG1), the proposal unit 408 transmits recommendation information to the first terminal device 5 (Step SG3).

As shown in the flowchart FH, upon receiving the recommendation information (Step SH1), the first app execution unit 501 of the first terminal device 5 displays the received recommendation information on the first terminal touch panel 52 (Step SH2). Note that the recommendation information may contain the information indicating that an incentive is awarded by the use of the electric kick scooter 2.

Then, the first app execution unit 501 determines whether input indicating the use of the electric kick scooter 2 is accepted (Step SH3). When determined negative in Step SH3, the first app execution unit 501 performs determination of Step SH3 again.

When determined that input indicating the use of the electric kick scooter 2 is accepted (YES in Step SH3), the first app execution unit 501 transmits, to the server device 4, use start information indicating that the use of the electric kick scooter 2 is started (Step SH4). The use start information contains the usable person ID.

As shown in the flowchart FG, the second calculation unit 409 of the server device 4 determines whether the reception unit 401 has received the use start information (Step SG4).

When determined that the reception unit 401 has not received the use start information (NO in Step SG4), the second calculation unit 409 of the server device 4 determines whether the record as the processing target is erased (Step SG5).

When the second calculation unit 409 determines that the record as the processing target is erased (YES in Step SG5), the server processor 40 ends the processing.

In the meantime, when determined that the record as the processing target is not erased (NO in Step SG5), the second calculation unit 409 performs the processing of Step SG4 again.

Returning to describing Step SG4, when determined that the reception unit 401 has received the use start information (YES in Step SG4), the second calculation unit 409 determines whether the rent-out information containing the driver ID contained in the record as the processing target is received (Step SG6).

When determined that the rent-out information containing the driver ID contained in the record as the processing target is received (YES in Step SG6), the second calculation unit 409 calculates the incentive (Step SG7). After calculating the incentive, the second calculation unit 409 outputs information of the calculated incentive to the database processing unit 411. The usable person ID contained in the use start information is associated with the information of the incentive that is output to the database processing unit 411.

Then, the database processing unit 411 updates the usable person DB 424 (Step SG8). Step SG8 will be described in detail. The database processing unit 411 specifies, from the usable person DB 424, the record having the usable person ID output from the second calculation unit 409. Then, the database processing unit 411 updates the information of the incentive in the specified record to the information in which the incentive calculated by the second calculation unit 409 is added.

### 6. Anther Embodiment

In the embodiment described above, the proposal unit 408 is a configuration that proposes the use of the electric kick scooter 2 in accordance with the traffic condition. However, the proposal unit 408 may propose the use of the electric kick scooter 2 depending on the needs of the usable person P. In the present embodiment, the needs of the usable person P indicate the desire that the usable person P hopes to do in the surroundings of the destination. The proposal unit 408 acquires the needs of the usable person P from the usable person P. For example, the first app execution unit 501 accepts the things desired to do in the surroundings of the destination as one of various kinds of information related to dispatch. Then, the proposal unit 408 searches for the facilities where the usable person P can do the accepted things and, when searched, proposes the use of the electric kick scooter 2.

Another embodiment may be configured such that the first taxi 3A to be dispatched for the usable person P is selected based on the charge amount of the battery 21 of the electric kick scooter 2 loaded on the first taxi 3A. That is, when the determination unit 402 determines that the first taxi 3A is necessary for the usable person P and there are a plurality of first taxies 3A to be selectable, the first selection unit 403 preferentially selects the one carrying the battery 21 with the largest charge amount. In that case, among the records stored in the taxi DB 423, the record of the first taxi 3A contains the mobile body ID of the electric kick scooter 2 loaded on the first taxi 3A. The first selection unit 403 refers to the mobile body DB 422 and the taxi DB 423 to make selection of the first taxi 3A based on the charge amount.

While the server device 4 selects the transportation means in the embodiment described above, the usable person P may select the transportation means in another embodiment. In such a configuration, the first calculation unit 406 calculates the required time from the riding location to the destination written in various kinds of information related to dispatch for each of the first transportation means, the second transportation means, and the third transportation means. Then, the providing unit 407 provides a combination of the first transportation means and the required time when the first transportation means is used for the transportation, a combination of the second transportation means and the required time when the second transportation means is used for the transportation, and a combination of the third transportation means and the required time when the third transportation means is used for the transportation to the usable person P. This is implemented by transmitting the information to the first terminal device 5. Note that each required time in the combinations is the required time calculated by the first calculation unit 406. The first app execution unit 501 accepts input for confirming the dispatch reservation, accepts selection of the transportation means made by the usable person, and transmits the dispatch reservation information to the server device 4. In the dispatch reservation information, information of the transportation means selected by the usable person P is recorded. The determination unit 402 determines whether the first taxi 3A is necessary for the usable person P, by taking the transportation means selected by the usable person P into consideration as well. For example, when the usable person P selects the first transportation means, the determination unit 402 makes determination by the determination method described in the embodiment above. Furthermore, for example, when the usable person P selects the second transportation means, the determination unit 402 determines that the first taxi 3A is necessary. Moreover, for example, when the usable person P selects the third transportation means, the determination unit 402 makes determination by the determination method described in the embodiment above.

While the electric kick scooter 2 is discussed in the embodiment described above as the mobile body of the present disclosure, the mobile body is not limited to the electric kick scooter 2. The mobile body of the present disclosure only needs to be ridable and to be able to loaded on the taxi 3.

While the taxi 3 is discussed in the embodiment described above as the vehicle of the present disclosure, the vehicle of the present disclosure is not limited to the taxi 3. The vehicle of the present disclosure only needs to be a vehicle that can be dispatched and can carry the electric kick scooter 2 loaded thereon.

The server processor 40, the first terminal processor 500, and the second terminal processor 600 may be configured with a single processor or may be configured with a plurality of processors. The server processor 40, the first terminal processor 500, and the second terminal processor 600 may also be hardware programmed to implement corresponding functional units. That is, the server processor 40, the first terminal processor 500, and the second terminal processor 600 may be configured with ASIC (Application Specific Integrated Circuit) or FPGA (Field Programmable Gate Array), for example.

Furthermore, each of the units of the server device 4, the first terminal device 5, and the second terminal device 6 shown in FIG. 2 and FIG. 3 is presented as an example only, and there is no specific limit set for the concrete implementation forms thereof. That is, hardware individually corresponding to each of the units does not necessarily need to be mounted, and it is certainly possible to implement functions of each of the units by executing a program by a single processor. Furthermore, part of the functions implemented by software in the embodiments described above may be configured with hardware, or part of the functions implemented by hardware may be implemented by software. In addition, specific detailed configurations of each of other units of the server device 4, the first terminal device 5, and the second terminal device 6 can be changed arbitrarily.

Furthermore, for example, step units of the operations shown in FIG. 4, FIG. 5, FIG. 6, and FIG. 7 are divided in accordance with the main processing contents in order to facilitate understanding of the operations, and the present invention is not limited by the manner by which the processing units are divided and the names thereof. The operations may be divided into a greater number of step units in accordance with the processing contents. Furthermore, a single step unit may be divided to include more processing. Moreover, the order of the steps may be changed as appropriate without departing from the spirit of the present invention.

### 7. Configuration Supported by the Embodiments

The above-described embodiments support the following configurations.

(Configuration 1) A dispatch system dispatching a vehicle to a dispatch target person, the dispatch system including: an acceptance unit configured to accept a dispatch reservation of the vehicle from the dispatch target person; a determination unit configured to determine whether a first vehicle that is the vehicle loading a ridable mobile body is necessary for the dispatch target person, based on the dispatch reservation accepted by the acceptance unit; and a first selection unit configured to select the vehicle to be dispatched for the dispatch target person, in which the first selection unit: selects the first vehicle, when the determination unit determines that the first vehicle is necessary for the dispatch target person; and selects a second vehicle that is the vehicle not loading the mobile body, when the determination unit determines that the first vehicle is not necessary for the dispatch target person.

According to the dispatch system of configuration 1, the vehicle loading the mobile body or the vehicle not loading the mobile body is dispatched based on whether the mobile body is necessary for the dispatch target person, so that it is possible to provide dispatch convenient for the dispatch target person.

(Configuration 2) The dispatch system according to configuration 1, in which a destination of the dispatch target person is set in the dispatch reservation accepted by the acceptance unit, and the determination unit determines whether the first vehicle is necessary for the dispatch target person, based on the destination of the dispatch target person set in the dispatch reservation.

The dispatch system of configuration 2 can determine whether the mobile body is necessary for the dispatch target person based on the destination, so that it is possible to dispatch the vehicle loading the mobile body or the vehicle not loading the mobile body according to the destination. Depending on the destinations, the vehicle to be dispatched may only go to the surroundings of the destination. Furthermore, the dispatch target person may leave the mobile body in the dispatched vehicle at the destination. The dispatch system of configuration 2 can dispatch the vehicle loading the mobile body or the vehicle not loading the mobile body in accordance with the destination. Therefore, it is possible to deal with such cases, and provide dispatch convenient for the dispatch target person.

(Configuration 3) The dispatch system according to configuration 2, in which the determination unit determines whether the first vehicle is necessary for the dispatch target person, based on whether the dispatch target person uses the mobile body before riding in the vehicle.

According to the dispatch system of configuration 3, it is possible to dispatch the vehicle not loading the mobile body when the dispatch target person uses the mobile body before riding in the vehicle, and it is also possible to dispatch the vehicle loading the mobile body when the dispatch target person does not use the mobile body before riding in the vehicle. This makes it possible to provide dispatch convenient for the dispatch target person.

(Configuration 4) The dispatch system according to configuration 3, in which the determination unit: determines that the first vehicle is necessary for the dispatch target person, when the dispatch target person uses the mobile body before riding in the vehicle and the dispatch target person uses the mobile body loaded on the vehicle; and determines that the first vehicle is not necessary for the dispatch target person, when the dispatch target person uses the mobile body before riding in the vehicle and the dispatch target person does not use the mobile body loaded on the vehicle.

According to the dispatch system of configuration 4, when the dispatch target person uses the mobile body before riding in the vehicle, it is possible to dispatch an appropriate vehicle depending on whether the dispatch target person hopes to use the mobile body loaded on the vehicle. This makes it possible to provide dispatch more convenient for the dispatch target person.

(Configuration 5) The dispatch system according to any one of configurations 1 to 4, in which the mobile body includes a first charging device as a drive source, and the first selection unit: determines whether the dispatch target person is requesting to charge the first charging device; and when determined that the dispatch target person is requesting to charge the first charging device, selects the second vehicle that includes a second charging device capable of charging the first charging device.

According to the dispatch system of configuration 5, the mobile body can be charged by the dispatched vehicle. Therefore, it is possible to increase the possibility of being capable of using the mobile body after riding in the dispatched vehicle, thereby making it possible to provide dispatch convenient for the dispatch target person.

(Configuration 6) The dispatch system according to any one of configurations 1 to 5, including: a second selection unit configured to select transportation means for a destination of the dispatch target person; and a providing unit configured to provide, to the dispatch target person, the transportation means selected by the second selection unit, in which the second selection unit selects the transportation means using at least one selected from the vehicle and the mobile body, based on a traffic condition and a destination of the dispatch target person.

According to the dispatch system of configuration 6, the transportation means is provided. This allows the dispatch target person making a dispatch reservation to grasp what kind of transportation means to take for reaching the destination when making the dispatch reservation. Therefore, it is possible to improve the convenience for the dispatch target person in making the dispatch reservation, thereby making it possible to provide dispatch convenient for the dispatch target person.

(Configuration 7) The dispatch system according to configuration 6, including a first calculation unit configured to calculate required time for reaching the destination of the dispatch target person corresponding to the transportation means selected by the second selection unit, in which the providing unit provides, to the dispatch target person, the transportation means and also the required time calculated by the first calculation unit.

According to the dispatch system of configuration 7, the transportation means and the required time are provided. This allows the dispatch target person making a dispatch reservation to grasp what kind of transportation means to take for reaching the destination and how long it takes to reach the destination when making the dispatch reservation. Therefore, the convenience for the dispatch target person in making the dispatch reservation can be improved further, so that it is possible to provide dispatch more convenient for the dispatch target person.

(Configuration 8) The dispatch system according to any one of configurations 1 to 5, including a first calculation unit configured to calculate required time for reaching a destination of the dispatch target person, for each of a plurality of types of transportation means used for reaching the destination of the dispatch target person; and a providing unit configured to provide, to the dispatch target person, the transportation means for the destination of the dispatch target person and the required time calculated by the first calculation unit, for each of the plurality of types of the transportation means.

According to the dispatch system of configuration 8, the transportation means and the required time for the destination of the dispatch target person are provided for each of a plurality of types of transportation means. Therefore, the dispatch target person making a dispatch reservation can grasp what types of transportation means there are and how long it takes to reach the destination for each type of the transportation means in making the dispatch reservation. Furthermore, this also allows the dispatch target person to select the transportation means for the destination. Therefore, the convenience for the dispatch target person in making the dispatch reservation can be improved further.

(Configuration 9) The dispatch system according to any one of configurations 6 to 8, including a proposal unit configured to propose use of the mobile body to the dispatch target person, in accordance with needs of the dispatch target person or the traffic condition.

According to the dispatch system of configuration 9, the use of the mobile body can be appropriately proposed to the dispatch target person, so that it is possible to appropriately support a transportation plan for the destination and a plan in the surroundings of the destination. This makes it possible to provide dispatch convenient for the dispatch target person and to support the plans of the dispatch target person appropriately.

(Configuration 10) The dispatch system according to configuration 9, including a second calculation unit configured to calculate an incentive awarded to the dispatch target person, when the dispatch target person conducts the use of the mobile body proposed by the proposal unit.

The dispatch system of configuration 10 can stimulate the desire to use the mobile body, so that it is possible to increase the possibility of using the mobile body as proposed.

(Configuration 11) The dispatch system according to any one of configurations 1 to 10, in which the mobile body loaded on the first vehicle is capable of being rented out to the dispatch target person, and the dispatch system includes a request unit configured to request a driver of the first vehicle that the mobile body is rented out to load the mobile body that is located within a prescribed range from a current location of the first vehicle.

The dispatch system of configuration 11 can suppress reduction in the number of vehicles loading the mobile body, so that it is possible to stably dispatch the vehicles loading the mobile body. This makes it possible to provide dispatch convenient for the dispatch target person stably.

(Configuration 12) A control method of a dispatch system dispatching a vehicle to a dispatch target person, the control method including: accepting a dispatch reservation of the vehicle from the dispatch target person; determining whether a first vehicle that is the vehicle loading a ridable mobile body is necessary for the dispatch target person, based on the accepted dispatch reservation; selecting the first vehicle as the vehicle to be dispatched for the dispatch target person, when determined that the first vehicle is necessary for the dispatch target person; and selecting a second vehicle that is the vehicle not loading the mobile body as the vehicle to be dispatched for the dispatch target person, when determined that the first vehicle is not necessary for the dispatch target person.

According to the control method of the dispatch system of configuration 12, it is possible to achieve the same operations and effects as those of the dispatch system of configuration 1.

### REFERENCE SIGNS LIST

1 Dispatch system

2 Electric kick scooter (mobile body)

3 Taxi (vehicle)

3A First taxi (first vehicle)

3B Second taxi (second vehicle)

4 Server device

5 First terminal device

6 Second terminal device

21 Battery (first charging device)

32 Battery (second charging device)

40 Server processor

42 Server memory

44 Server communication unit

401 Reception unit (acceptance unit)

402 Determination unit

403 First selection unit

404 Order unit

405 Second selection unit

406 First calculation unit

407 Providing unit

408 Proposal unit

409 Second calculation unit

410 Request unit

411 Database processing unit

421 Control program

422 Mobile body DB

423 Taxi DB

424 Usable person DB

425 Driver DB

426 Destination DB

427 Station DB

428 Dispatch order management DB

429 Map data

P Usable person (dispatch target person)

What is claimed is:

1. A dispatch system dispatching a vehicle to a dispatch target person, the dispatch system comprising:
an acceptance unit configured to accept a dispatch reservation of the vehicle from the dispatch target person;
a determination unit configured to determine whether a first vehicle that is the vehicle loading a ridable mobile body is necessary for the dispatch target person, based on the dispatch reservation accepted by the acceptance unit; and
a first selection unit configured to select the vehicle to be dispatched for the dispatch target person, wherein
the first selection unit:
selects the first vehicle, when the determination unit determines that the first vehicle is necessary for the dispatch target person; and
selects a second vehicle that is the vehicle not loading the mobile body, when the determination unit determines that the first vehicle is not necessary for the dispatch target person.

2. The dispatch system according to claim 1, wherein
a destination of the dispatch target person is set in the dispatch reservation accepted by the acceptance unit, and
the determination unit determines whether the first vehicle is necessary for the dispatch target person, based on the destination of the dispatch target person set in the dispatch reservation.

3. The dispatch system according to claim 2, wherein the determination unit determines whether the first vehicle is necessary for the dispatch target person, based on whether the dispatch target person uses the mobile body before riding in the vehicle.

4. The dispatch system according to claim 3, wherein
the determination unit:
determines that the first vehicle is necessary for the dispatch target person, when the dispatch target person uses the mobile body before riding in the vehicle and the dispatch target person uses the mobile body loaded on the vehicle; and
determines that the first vehicle is not necessary for the dispatch target person, when the dispatch target person uses the mobile body before riding in the vehicle and the dispatch target person does not use the mobile body loaded on the vehicle.

5. The dispatch system according to claim 1, wherein
the mobile body includes a first charging device as a drive source, and
the first selection unit: determines whether the dispatch target person is requesting to charge the first charging device; and when determined that the dispatch target person is requesting to charge the first charging device, selects the second vehicle that includes a second charging device capable of charging the first charging device.

6. The dispatch system according to claim 1, comprising:
a second selection unit configured to select transportation means for a destination of the dispatch target person; and
a providing unit configured to provide, to the dispatch target person, the transportation means selected by the second selection unit, wherein
the second selection unit selects the transportation means using at least one selected from the vehicle and the mobile body, based on a traffic condition and a destination of the dispatch target person.

7. The dispatch system according to claim 6, comprising a first calculation unit configured to calculate required time for reaching the destination of the dispatch target person corresponding to the transportation means selected by the second selection unit, wherein
the providing unit provides, to the dispatch target person, the transportation means and also the required time calculated by the first calculation unit.

8. The dispatch system according to claim 1, comprising a first calculation unit configured to calculate required time for reaching a destination of the dispatch target person, for each of a plurality of types of transportation means used for reaching the destination of the dispatch target person; and
a providing unit configured to provide, to the dispatch target person, the transportation means for the destination of the dispatch target person and the required time calculated by the first calculation unit, for each of the plurality of types of the transportation means.

9. The dispatch system according to claim 6, comprising a proposal unit configured to propose use of the mobile body to the dispatch target person, in accordance with needs of the dispatch target person or the traffic condition.

10. The dispatch system according to claim 9, comprising a second calculation unit configured to calculate an incentive awarded to the dispatch target person, when the dispatch target person conducts the use of the mobile body proposed by the proposal unit.

11. The dispatch system according to claim 1, wherein
the mobile body loaded on the first vehicle is capable of being rented out to the dispatch target person, and
the dispatch system comprises a request unit configured to request a driver of the first vehicle that the mobile body is rented out to load the mobile body that is located within a prescribed range from a current location of the first vehicle.

12. A control method of a dispatch system dispatching a vehicle to a dispatch target person, the control method comprising:
accepting a dispatch reservation of the vehicle from the dispatch target person;
determining whether a first vehicle that is the vehicle loading a ridable mobile body is necessary for the dispatch target person, based on the accepted dispatch reservation;
selecting the first vehicle as the vehicle to be dispatched for the dispatch target person, when determined that the first vehicle is necessary for the dispatch target person; and
selecting a second vehicle that is the vehicle not loading the mobile body as the vehicle to be dispatched for the dispatch target person, when determined that the first vehicle is not necessary for the dispatch target person.
